(19) United States
(12) Patent Application Publication
(10) Pub. No.: US 2013/0038882 A1
(43) Pub. Date: Feb. 14, 2013

(54) OBJECT DETECTING DEVICE AND INFORMATION ACQUIRING DEVICE

(71) Applicants: Katsumi UMEDA, Aichi (JP); Takaaki Morimoto, Kakogawa-Shi (JP)

(72) Inventors: Katsumi UMEDA, Aichi (JP); Takaaki Morimoto, Kakogawa-Shi (JP)

(73) Assignee: SANYO Electric Co., Ltd., Moriguchi-shi (JP)

(21) Appl. No.: 13/588,857

(22) Filed: Aug. 17, 2012

Related U.S. Application Data
(63) Continuation of application No. PCT/JP2010/069410, filed on Nov. 1, 2010.

(30) Foreign Application Priority Data
Feb. 17, 2009 (JP) 2010-032845

(51) Int. Cl. G01B 11/24; G01B 11/25

(52) U.S. Cl. 356/610; 356/601

(57) ABSTRACT

An information acquiring device has a light source which emits light in a predetermined wavelength band; a projection optical system which projects the light toward a target area; and a light receiving element which receives reflected light reflected on the target area for outputting a signal. First signal value information relating to a value of a signal outputted from the light receiving element during a period when the light is emitted from the light source, and second signal value information relating to a value of a signal outputted from the light receiving element during a period when the light is not emitted from the light source are stored in a storage. An information acquiring section acquires three-dimensional information of an object in the target area, based on a subtraction result obtained by subtracting the second signal value information from the first signal value information stored in the storage.

This application claims priority under 35 U.S.C. Section 119 of Japanese Patent Application No. 2010-32845 filed Feb. 17, 2010, entitled “OBJECT DETECTING DEVICE AND INFORMATION ACQUIRING DEVICE”. The disclosure of the above application is incorporated herein by reference.

### BACKGROUND OF THE INVENTION

1. Field of the Invention

The present invention relates to an object detecting device for detecting an object in a target area, based on a state of reflected light when light is projected onto the target area, and an information acquiring device incorporated with the object detecting device.

2. Disclosure of Related Art

Conventionally, there has been developed an object detecting device using light in various fields. An object detecting device incorporated with a so-called distance image sensor is operable to detect not only a two-dimensional image on a two-dimensional plane but also a depthwise shape or a movement of an object to be detected. In such an object detecting device, light in a predetermined wavelength band is projected from a laser light source or an LED (Light Emitting Diode) onto a target area, and light reflected on the target area is received by a light receiving element such as a CMOS image sensor. Various types of sensors are known as the distance image sensor.

A distance image sensor configured to scan a target area with laser light is operable to detect a distance to each portion (each scanning position) of an object to be detected, based on a time lag between a light emission timing and a light receiving timing of laser light at each scanning position.

Further, a distance image sensor which is configured to irradiate a target area with laser light having a predetermined dot pattern is operable to receive reflected light of laser light from the target area at each dot position on the dot pattern by a light receiving element. The distance image sensor is operable to detect a distance to each portion (each dot position on the dot pattern) of an object to be detected, based on the light receiving position of laser light on the light receiving element corresponding to each dot position, using a triangulation method (see e.g. pp. 1279-1280, the 19th Annual Conference Proceedings (Sep. 18th-20th, 2001) by the Robotics Society of Japan).

In addition to the above, there is also known a distance image sensor according to a so-called stereo camera method for detecting a distance to each portion of an object to be detected by stereoscopically viewing a target area by a plurality of cameras disposed at different angular positions (see e.g. pp. 1279-1280, the 19th Annual Conference Proceedings (Sep. 18th-20th, 2001) by the Robotics Society of Japan).

In the object detecting device thus constructed, it is possible to enhance the object detection precision by disposing a filter which is configured to guide only the light in a certain wavelength band emitted from a laser light source or a like device to a light receiving element. A narrow band-pass filter having the aforementioned wavelength band as a transmittance wavelength band may be used as such a filter.

Even with use of such a filter, however, it is impossible to completely match the transmittance wavelength band of the filter with an emission wavelength band of a laser light source, because the emission wavelength band of each laser light source or a like device has an individual tolerance. In the above arrangement, it is possible to adjust the transmittance wavelength band of the filter by e.g. changing an inclination angle of the filter with respect to reflected light. However, the above adjustment requires an operation of adjusting the inclination angle of the filter. Further, the amount of light to be reflected on the filter surface may increase by inclining the filter, and as a result, the amount of light to be received on the light receiving element may decrease. In addition to the above, the narrow band-pass filter is expensive.

Further, the wavelength of light to be emitted from a laser light source changes as the temperature of the laser light source changes. In view of this, a temperature adjusting element such as a Peltier element is necessary for suppressing a temperature change of a light source so as to keep the emission wavelength constant when the laser light source is actually operated.

### SUMMARY OF THE INVENTION

A first aspect according to the invention is directed to an information acquiring device for acquiring information on a target area using light. The information acquiring device according to the first aspect includes a light source which emits light in a predetermined wavelength band; a light source controller which controls the light source; a projection optical system which projects the light emitted from the light source toward the target area; a light receiving element which receives reflected light reflected on the target area for outputting a signal; a storage which stores signal value information relating to a value of the signal outputted from the light receiving element; and an information acquiring section which acquires three-dimensional information of an object in the target area based on the signal value information stored in the storage. In this arrangement, the light source controller controls the light source to repeat emission and non-emission of the light. The storage stores first signal value information relating to a value of a signal outputted from the light receiving element during a period when the light is emitted from the light source, and second signal value information relating to a value of a signal outputted from the light receiving element during a period when the light is not emitted from the light source. The information acquiring section acquires the three-dimensional information of the object in the target area, based on a subtraction result obtained by subtracting the second signal value information from the first signal value information stored in the storage.

A second aspect according to the invention is directed to an object detecting device. The object detecting device according to the second aspect has the information acquiring device according to the first aspect.

### BRIEF DESCRIPTION OF THE DRAWINGS

These and other objects, and novel features of the present invention will become more apparent upon reading the following detailed description of the embodiment along with the accompanying drawings.

FIG. 1 is a diagram showing an arrangement of an object detecting device embodying the invention.

FIG. 2 is a diagram showing an arrangement of an information acquiring device and an information processing device in the embodiment.

FIGS. 3A and 3B are diagrams respectively showing an irradiation state of laser light onto a target area, and a light receiving state of laser light on an image sensor in the embodiment.

FIG. 4 is a timing chart showing a light emission timing of laser light, an exposure timing for the image sensor, and an image data storing timing in the embodiment.

FIG. 5 is a flowchart showing an image data storing processing in the embodiment.

FIGS. 6A and 6B are a flowchart showing an image data subtraction processing in the embodiment.

FIGS. 7A through 7D are diagrams schematically showing an image data processing process in the embodiment.

FIG. 8 is a timing chart showing a light emission timing of laser light, an exposure timing for an image sensor, and an image data storing timing as a modification of the embodiment.

The drawings are provided mainly for describing the present invention, and do not limit the scope of the present invention.

### DESCRIPTION OF PREFERRED EMBODIMENTS

In the following, an embodiment of the invention is described referring to the drawings. The embodiment is an example, wherein the invention is applied to an information acquiring device which is configured to irradiate a target area with laser light having a predetermined dot pattern.

In the embodiment, a laser light source 111 corresponds to a “light source” in the claims. A laser controller 21a corresponds to a “light source controller” in the claims. A CMOS image sensor 125 corresponds to a “light receiving element” in the claims. A memory 25 corresponds to a “storage” in the claims. A data subtractor 21b and a distance calculator 21c correspond to an “information acquiring section” in the claims. First image data and second image data respectively correspond to “first signal value information” and “second signal value information” in the claims. The description regarding the correspondence between the claims and the embodiment is merely an example, and the claims are not limited by the description of the embodiment.

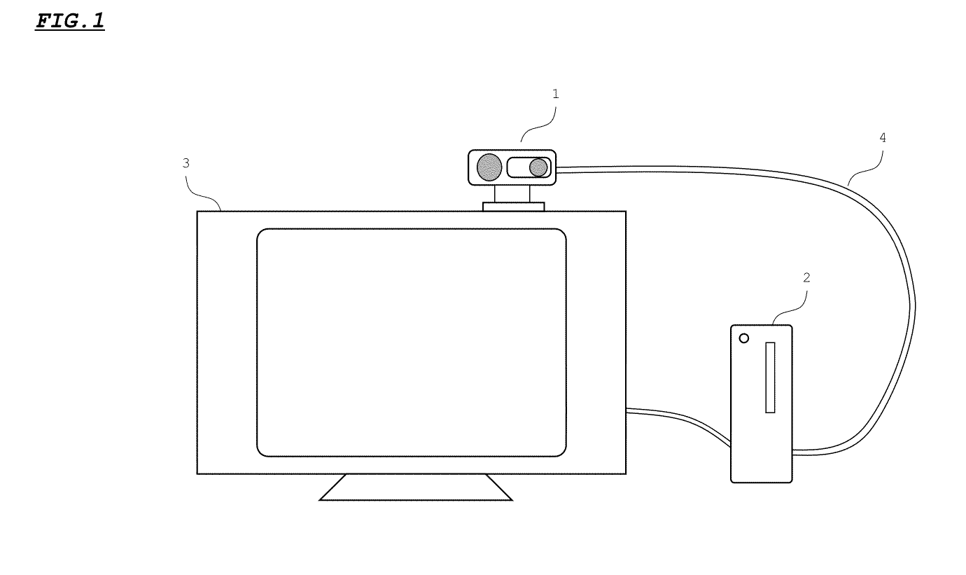

Firstly, a schematic arrangement of an object detecting device according to the first embodiment is described. As shown in FIG. 1, the object detecting device is provided with an information acquiring device 1, and an information processing device 2. A TV 3 is controlled by a signal from the information processing device 2.

The information acquiring device 1 projects infrared light to the entirety of a target area, and receives reflected light from the target area by a CMOS image sensor to thereby acquire a distance (hereinafter, called as “three-dimensional distance information”) to each part of an object in the target area. The acquired three-dimensional distance information is transmitted to the information processing device 2 through a cable 4.

The information processing device 2 is e.g. a controller for controlling a TV or a game machine, or a personal computer. The information processing device 2 detects an object in a target area based on three-dimensional distance information received from the information acquiring device 1, and controls the TV 3 based on a detection result.

For instance, the information processing device 2 detects a person based on received three-dimensional distance information, and detects a motion of the person based on a change in the three-dimensional distance information. For instance, in the case where the information processing device 2 is a controller for controlling a TV, the information processing device 2 is installed with an application program operable to detect a gesture of a user based on received three-dimensional distance information, and output a control signal to the TV 3 in accordance with the detected gesture. In this case, the user is allowed to control the TV 3 to execute a predetermined function such as switching the channel or turning up/down the volume by performing a certain gesture while watching the TV 3.

Further, for instance, in the case where the information processing device 2 is a game machine, the information processing device 2 is installed with an application program operable to detect a motion of a user based on received three-dimensional distance information, and operate a character on a TV screen in accordance with the detected motion to change the match status of a game. In this case, the user is allowed to play the game as if the user himself or herself is the character on the TV screen by performing a certain action while watching the TV 3.

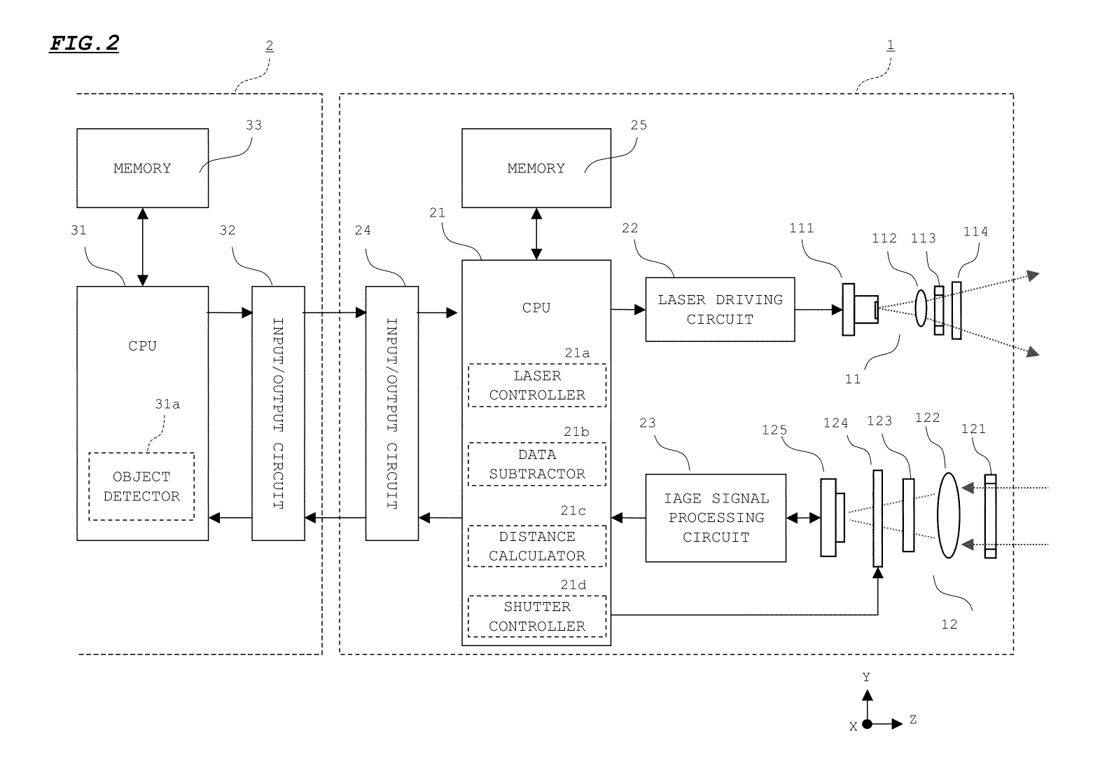

FIG. 2 is a diagram showing an arrangement of the information acquiring device 1 and the information processing device 2.

The information acquiring device 1 is provided with a projection optical system 11 and a light receiving optical system 12, which constitute an optical section. The projection optical system 11 is provided with a laser light source 111, a collimator lens 112, an aperture 113, and a diffractive optical element (DOE) 114. The light receiving optical system 12 is provided with an aperture 121, an imaging lens 122, a filter 123, a shutter 124, and a CMOS image sensor 125. In addition to the above, the information acquiring device 1 is provided with a CPU (Central Processing Unit) 21, a laser driving circuit 22, an image signal processing circuit 23, an input/output circuit 24, and a memory 25, which constitute a circuit section.

The laser light source 111 outputs laser light in a narrow wavelength band of or about 830 nm. The collimator lens 112 converts the laser light emitted from the laser light source 111 into parallel light. The aperture 113 adjusts a light flux cross section of laser light into a predetermined shape. The DOE 114 has a diffraction pattern on an incident surface thereof. Laser light entered to the DOE 114 through the aperture 113 is converted into laser light having a dot matrix pattern by a diffractive action of the diffraction pattern, and is irradiated onto a target area.

Laser light reflected on the target area is entered to the imaging lens 122 through the aperture 121. The aperture 121 converts external light into convergent light in accordance with the F-number of the imaging lens 122. The imaging lens 122 condenses the light entered through the aperture 121 on the CMOS image sensor 125.

The filter 123 is a band-pass filter which transmits light in a wavelength band including the emission wavelength band (in the range of about 830 nm) of the laser light source 111, and blocks light in a visible light wavelength band. The filter 123 is not a narrow band-pass filter which transmits only light in a wavelength band of or about 830 nm, but is constituted of an inexpensive filter which transmits light in a relatively wide wavelength band including a wavelength of 830 nm.

The shutter 124 blocks or transmits light from the filter 123 in accordance with a control signal from the CPU 21. The shutter 124 is e.g. a mechanical shutter or an electronic shutter. The CMOS image sensor 125 receives light condensed on the imaging lens 122, and outputs a signal (electric charge) in accordance with a received light amount to the image signal processing circuit 23 pixel by pixel. In this example, the CMOS image sensor 125 is configured in such a manner that the output speed of signals to be outputted from the CMOS image sensor 125 is set high so that a signal (electric charge) at each pixel can be outputted to the image signal processing circuit 23 with high response from a light receiving timing at each pixel.

The CPU 21 controls the parts of the information acquiring device 1 in accordance with a control program stored in the memory 25. By the control program, the CPU 21 has functions of a laser controller 21a for controlling the laser light source 111, a data subtractor 21b to be described later, a three-dimensional distance calculator 21c for generating three-dimensional distance information, and a shutter controller 21d for controlling the shutter 124.

The laser driving circuit 22 drives the laser light source 111 in accordance with a control signal from the CPU 21. The image signal processing circuit 23 controls the CMOS image sensor 125 to successively read signals (electric charges) from the pixels, which have been generated in the CMOS image sensor 125, line by line. Then, the image signal processing circuit 23 outputs the read signals successively to the CPU 21. The CPU 21 calculates a distance from the information acquiring device 1 to each portion of an object to be detected, by a processing to be implemented by the three-dimensional distance calculator 21c, based on the signals (image signals) to be supplied from the image signal processing circuit 23. The input/output circuit 24 controls data communications with the information processing device 2.

The information processing device 2 is provided with a CPU 31, an input/output circuit 32, and a memory 33. The information processing device 2 is provided with e.g. an arrangement for communicating with the TV 3, or a drive device for reading information stored in an external memory such as a CD-ROM and installing the information in the memory 33, in addition to the arrangement shown in FIG. 2. The arrangements of the peripheral circuits are not shown in FIG. 2 to simplify the description.

The CPU 31 controls each of the parts of the information processing device 2 in accordance with a control program (application program) stored in the memory 33. By the control program, the CPU 31 has a function of an object detector 31a for detecting an object in an image. The control program is e.g. read from a CD-ROM by an unillustrated drive device, and is installed in the memory 33.

For instance, in the case where the control program is a game program, the object detector 31a detects a person and a motion thereof in an image based on three-dimensional distance information supplied from the information acquiring device 1. Then, the information processing device 2 causes the control program to execute a processing for operating a character on a TV screen in accordance with the detected motion.

Further, in the case where the control program is a program for controlling a function of the TV 3, the object detector 31a detects a person and a motion (gesture) thereof in the image based on three-dimensional distance information supplied from the information acquiring device 1. Then, the information processing device 2 causes the control program to execute a processing for controlling a predetermined function (such as switching the channel or adjusting the volume) of the TV 3 in accordance with the detected motion (gesture).

The input/output circuit 32 controls data communication with the information acquiring device 1.

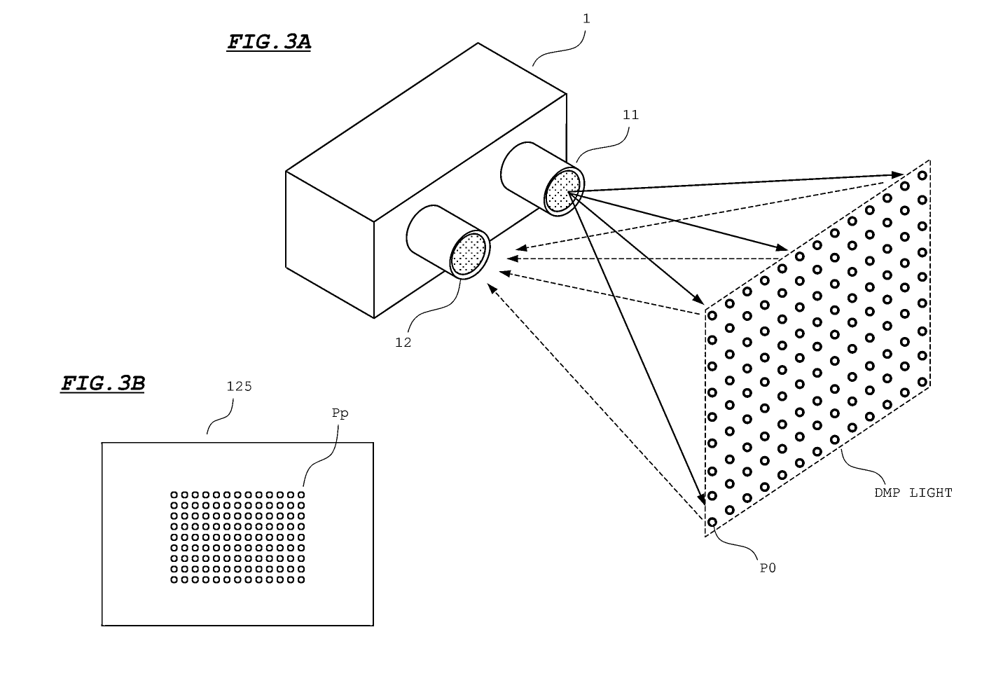

FIG. 3A is a diagram schematically showing an irradiation state of laser light onto a target area. FIG. 3B is a diagram schematically showing a light receiving state of laser light on the CMOS image sensor 125. To simplify the description, FIG. 3B shows a light receiving state in the case where a flat plane (screen) is disposed on a target area.

As shown in FIG. 3A, laser light (hereinafter, the entirety of laser light having a dot matrix pattern is called as “DMP light”) having a dot matrix pattern is irradiated from the projection optical system 11 onto a target area. FIG. 3A shows a light flux cross section of DMP light by a broken-line frame. Each dot in DMP light schematically shows a region where the intensity of laser light is locally enhanced by a diffractive action of the DOE 114. The regions where the intensity of laser light is locally enhanced appear in the light flux of DMP light in accordance with a predetermined dot matrix pattern.

In the case where a flat plane (screen) is disposed in a target area, light of DMP light reflected on the flat plane at each dot position is distributed on the CMOS image sensor 125, as shown in FIG. 3B. For instance, light at a dot position P0 on a target area corresponds to light at a dot position Pp on the CMOS image sensor 125.

The three-dimensional distance calculator 21c is operable to detect to which position on the CMOS image sensor 125, the light corresponding to each dot is entered, for detecting a distance to each portion (each dot position on a dot matrix pattern) of an object to be detected, based on the light receiving position, by a triangulation method. The details of the above detection technique is disclosed in e.g. pp. 1279-1280, the 19th Annual Conference Proceedings (Sep. 18th-20th, 2001) by the Robotics Society of Japan.

According to the distance detection as described above, it is necessary to accurately detect a distribution state of DMP light (light at each dot position) on the CMOS image sensor 125. However, since the inexpensive filter 123 having a relatively wide transmittance wavelength band is used in this embodiment, light other than DMP light may be entered to the CMOS image sensor 125, as ambient light. For instance, if an illuminator such as a fluorescent lamp is disposed in a target area, an image of the illuminator may be included in an image captured by the CMOS image sensor 125, which results in inaccurate detection of a distribution state of DMP light.

In view of the above, in this embodiment, detection of a distribution state of DMP light is optimized by the following processing.

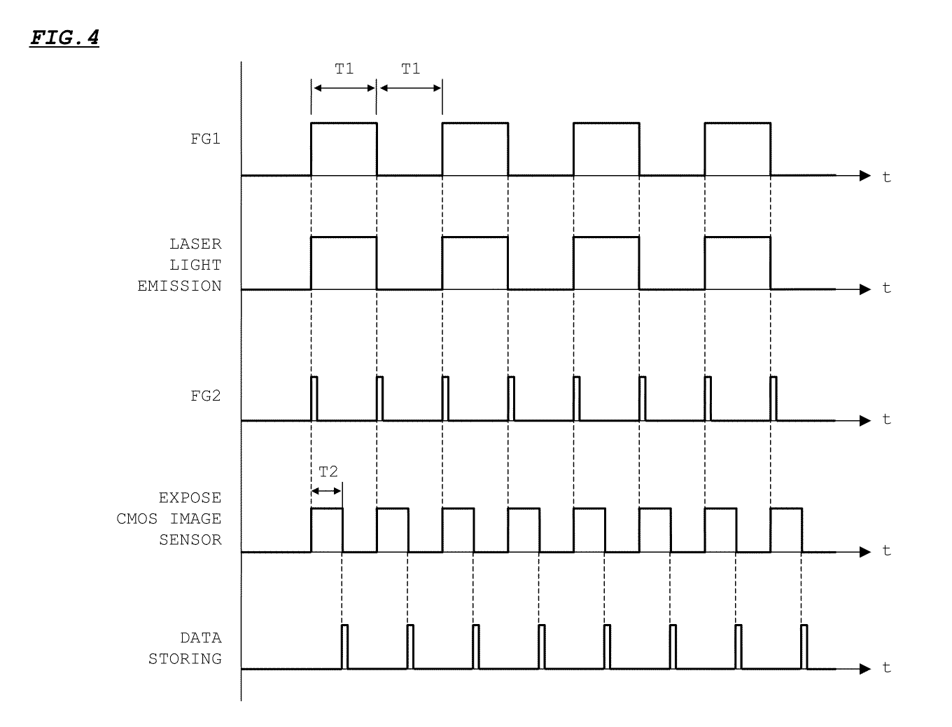

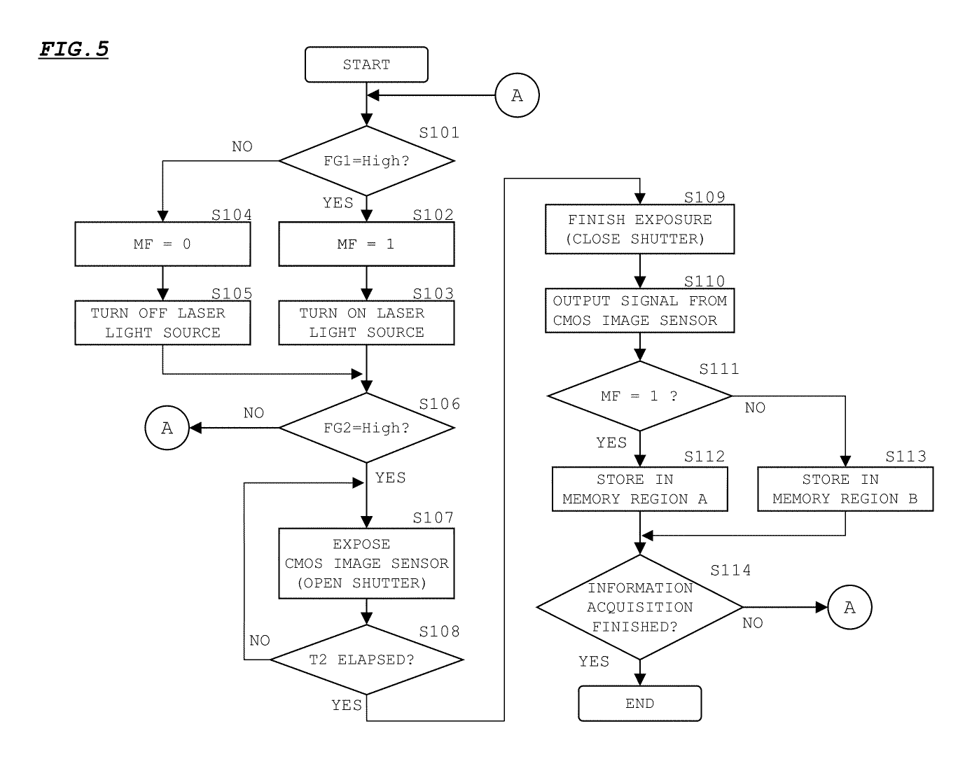

A DMP light imaging processing to be performed by the CMOS image sensor 125 is described referring to FIG. 4 and FIG. 5. FIG. 4 is a timing chart showing a light emission timing of laser light to be emitted from the laser light source 111, an exposure timing for the CMOS image sensor 125 and a storing timing of image data obtained by the CMOS image sensor 125 by the exposure. FIG. 5 is a flowchart showing an image data storing processing.

Referring to FIG. 4, the CPU 21 has functions of two function generators. With use of these functions, the CPU 21 generates pulses FG1 and FG2. The pulse FG1 is set high and low alternately at an interval T1. The pulse FG2 is outputted at a rising timing of the pulse FG1 and at a falling timing of the pulse FG1. For instance, the pulse FG2 is generated by differentiating the pulse FG1.

When the pulse FG1 is in a high-state, the laser controller 21a causes the laser light source 111 to be in an on state. Further, during a period T2 from the timing at which the pulse FG2 is set high, the shutter controller 21d causes the shutter 124 to be in an open state so that the CMOS image sensor 125 is exposed to light. After the exposure is finished, the CPU 21 causes the memory 25 to store image data obtained by the CMOS image sensor 125 by each exposure.

Referring to FIG. 5, if the pulse FG1 is set high (S101: YES), the CPU 21 sets a memory flag MF to 1 (S102), and causes the laser light source 111 to turn on (S103). Then, if the pulse FG2 is set high (S106: YES), the shutter controller 21d causes the shutter 124 to open so that the CMOS image sensor 125 is exposed to light (S107). The exposure is performed from an exposure start timing until the period T2 has elapsed (S108).

When the period T2 has elapsed from the exposure start timing (S108: YES), the shutter controller 21d causes the shutter 124 to close (S109), and image data obtained by the CMOS image sensor 125 is outputted to the CPU 21 (S110). Then, the CPU 21 determines whether the memory flag MF is set to 1 (S111). In this example, since the memory flag MF is set to 1 in Step S102 (S111: YES), the CPU 21 causes the memory 25 to store the image data outputted from the CMOS image sensor 125 into a memory region A of the memory 25 (S112).

Thereafter, if it is determined that the operation for acquiring information on the target area has not been finished (S114: NO), the processing returns to S101, and the CPU 21 determines whether the pulse FG1 is set high. If it is determined that that the pulse FG1 is set high, the CPU 21 continues to set the memory flag MF to 1 (S102), and causes the laser light source 111 to continue the on state (S103). Since the pulse FG2 is not outputted at this timing (see FIG. 4), the determination result in S106 is negative, and the processing returns to S101. In this way, the CPU 21 causes the laser light source 111 to continue the on state until the pulse FG1 is set low.

Thereafter, when the pulse FG1 is set low, the CPU 21 sets the memory flag MF to 0 (S104), and causes the laser light source 111 to turn off (S105). Then, if it is determined that the pulse FG2 is set high (S106: YES), the shutter controller 21d causes the shutter 124 to open so that the CMOS image sensor 125 is exposed to light (S107). The exposure is performed from an exposure start timing until the period T2 has elapsed in the same manner as described above (S108).

When the period T2 has elapsed from the exposure start timing (S108: YES), the shutter controller 21d causes the shutter 124 to close (S109), and image data obtained by the CMOS image sensor 125 is outputted to the CPU 21 (S110). Then, the CPU 21 judges whether the memory flag MF is set to 1 (S111). In this example, since the memory flag MF is set to 0 in Step S104 (S111: NO), the CPU 21 causes the memory 25 to store the image data outputted from the CMOS image sensor 125 into a memory region B of the memory 25 (S113).

The aforementioned processing is repeated until the information acquiring operation is finished. By performing the above processing, image data obtained by the CMOS image sensor 125 when the laser light source 111 is in an on state, and the image data obtained by the CMOS image sensor 125 when the laser light source 111 is in an off state are respectively stored in the memory region A and in the memory region B of the memory 25.

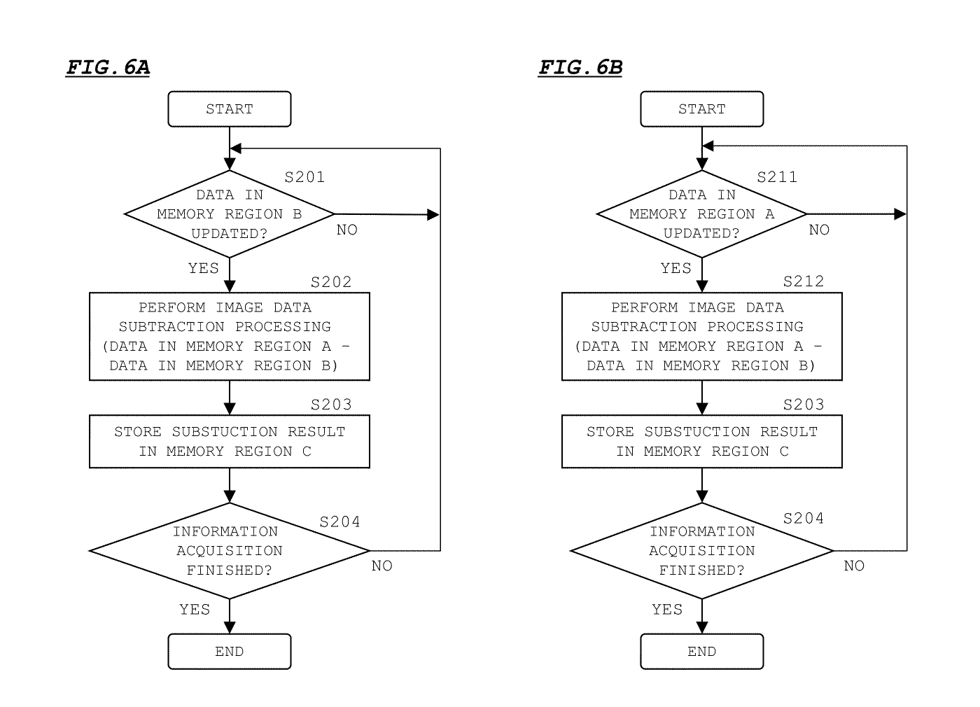

FIG. 6A is a flowchart showing a processing to be performed by the data subtractor 21b of the CPU 21.

When the image data is updated and stored in the memory region B (S201: YES), the data subtractor 21b performs a processing of subtracting the image data stored in the memory region B from the image data stored in the memory region A (S202). In this example, the value of a signal (electric charge) in accordance with a received light amount of each pixel which is stored in the memory region B is subtracted from the value of a signal (electric charge) in accordance with a received light amount of a pixel corresponding to the each pixel which is stored in the memory region A. The subtraction result is stored in a memory region C of the memory 25 (S203). If it is determined that the operation for acquiring information on the target area has not been finished (S204: NO), the processing returns to S201 and repeats the aforementioned processing.

By performing the processing shown in FIG. 6A, the subtraction result obtained by subtracting, from the image data (first image data) obtained when the laser light source 111 is in an on state, the image data (second image data) obtained when the laser light source 111 is in an off state immediately after the turning on of the laser light source 111, is updated and stored in the memory region C. In this example, as described above referring to FIGS. 4 and 5, the first image data and the second image data are acquired by exposing the CMOS image sensor 125 to light for the same period T2. Accordingly, the second image data corresponds to a noise component of light other than the laser light to be emitted from the laser light source 111, which is included in the first image data. Thus, image data obtained by removing a noise component of light other than the laser light to be emitted from the laser light source 111 is stored in the memory region C.

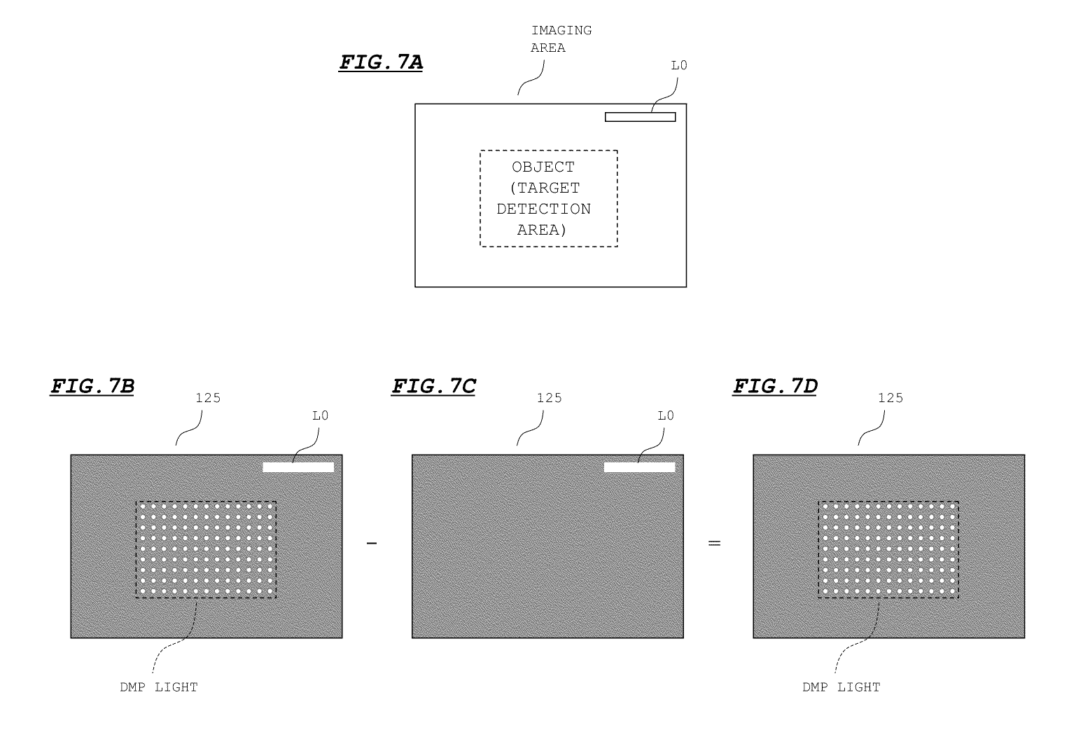

FIGS. 7A through 7D are diagrams schematically exemplifying an effect to be obtained by the processing shown in FIG. 6A.

As shown in FIG. 7A, in the case where a fluorescent lamp L0 is included in an imaging area, if the imaging area is captured by the light receiving optical system 12, while irradiating the imaging area with DMP light from the projection optical system 11 described in the embodiment, the captured image is as shown in FIG. 7B. Image data obtained based on the captured image in the above state is stored in the memory region A of the memory 25. Further, if the imaging area is captured by the light receiving optical system 12 without irradiating the imaging area with DMP light from the projection optical system 11, the captured image is as shown in FIG. 7C. Image data obtained based on the captured image in the above state is stored in the memory region B of the memory 25. A captured image obtained by removing the captured image shown in FIG. 7C from the captured image shown in FIG. 7B is as shown in FIG. 7D. Image data obtained based on the captured image shown in FIG. 7D is stored in the memory region C of the memory 25. Thus, image data obtained by removing a noise component of light (fluorescent light) other than DMP light is stored in the memory region C.

In this embodiment, a computation processing by the three-dimensional distance calculator 21c of the CPU 21 is performed, with use of the image data stored in the memory region C of the memory 25. This enhances the precision of three-dimensional distance information (information relating to a distance to each portion of an object to be detected) acquired by the above processing.

As described above, since the inexpensive filter 123 can be used in the embodiment, the embodiment is advantageous in reducing the cost. Further, even if there is a deviation in the wavelength of the laser light source 111, image data obtained by removing a noise component of light other than DMP light is acquired by the aforementioned subtraction processing. Thus, there is no need of adjusting a transmittance wavelength band by inclining the filter 123, or disposing a temperature adjusting element such as a Peltier element for suppressing a wavelength fluctuation of the laser light source 111.

As described above, the embodiment is advantageous in precisely acquiring three-dimensional distance information on an object to be detected in a target area, with a simplified arrangement.

In the case where a noise component is removed by performing the subtraction processing as described above, theoretically, it is possible to acquire image data by DMP light, even without using the filter 123. However, generally, the light amount of light in a visible light wavelength band is normally higher than the light amount of DMP light by several orders. Therefore, it is difficult to accurately extract only DMP light from light including a light component in a visible light wavelength band by the subtraction processing. In view of the above, in this embodiment, the filter 123 is disposed for removing visible light as described above. The filter 123 may be any filter, as far as the filter is capable of sufficiently reducing the light amount of visible light which may be entered to the CMOS image sensor 125. Further, the transmittance wavelength band of the filter 123 may lie in a range in which the wavelength of laser light is allowed to vary as the temperature of the laser light source 111 changes.

The embodiment of the invention has been described as above. The invention is not limited to the foregoing embodiment, and the embodiment of the invention may be changed or modified in various ways other than the above.

For instance, in FIG. 6A of the embodiment, a subtraction processing is performed as the data in the memory region B is updated. Alternatively, as shown in FIG. 6B, a subtraction processing may be performed as the data in the memory region A is updated. In the modification, if the data in the memory region A is updated (S211: YES), a processing of subtracting second image data from first image data which is updated and stored in the memory region A is performed, using the second image data stored in the memory region B immediately before the updating of the first image data (S212). Then, the subtraction result is stored in the memory region C (S203).

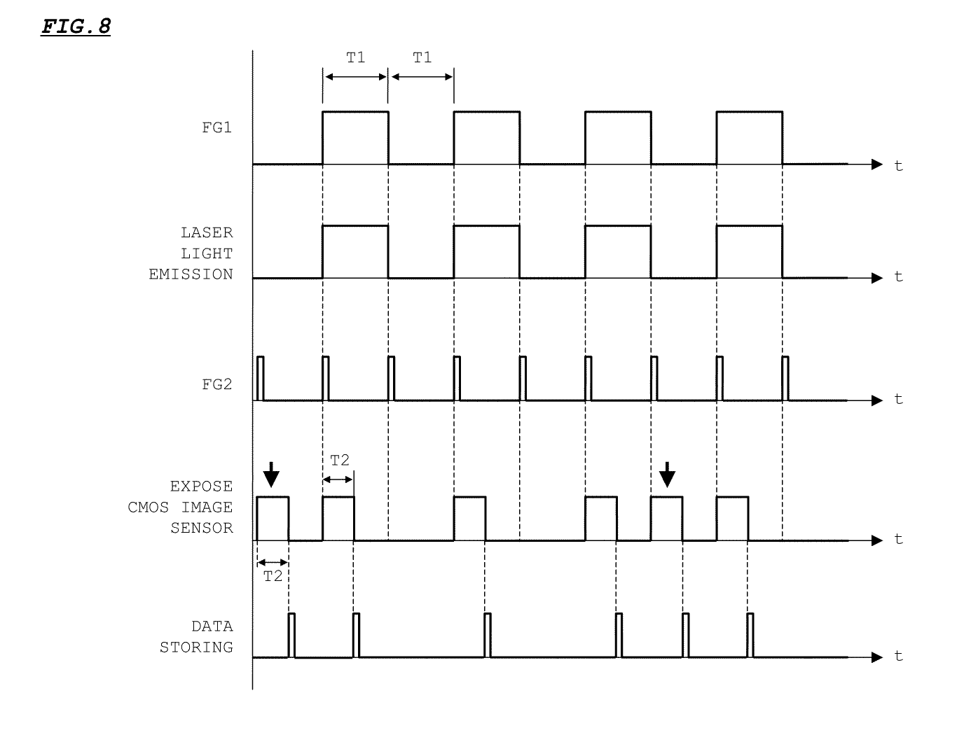

In the embodiment, as shown in the timing chart of FIG. 4, acquisition of the first image data and acquisition of the second image data are alternately performed. Alternatively, as shown in FIG. 8, acquisition of the second image data (indicated by the arrows in FIG. 8) may be performed each time the acquisition of the first image data is performed several times (three times in FIG. 8). In the modification, a subtraction processing of subtracting the first image data that has been acquired three times following acquisition of the second image data may be performed, using the acquired second image data, each time the first image data is acquired, and the subtraction result may be stored in the memory region C. The subtraction processing in the modification is performed in accordance with the flowchart shown in FIG. 6B.

The embodiment is an example, wherein the invention is applied to an information acquiring device incorporated with a distance image sensor which is configured to irradiate a target area with laser light having a dot matrix pattern. Alternatively, it is possible to apply the invention to an information acquiring device incorporated with a distance image sensor employing a TOF (Time of Flight) method, wherein a target area is scanned with laser light, and a distance to each portion (each scanning position) of an object to be detected is detected, based on a time lag between a light emission timing and a light receiving timing of laser light at each scanning position, or to an information acquiring device incorporated with a distance image sensor employing a stereo camera method. In the distance image sensor employing the TOF method, it is possible to use a light receiving element for detecting a received light amount of an entirety of a light receiving surface, without using a light receiving element having pixels.

In the embodiment, the CMOS image sensor 125 is used as a light receiving element. Alternatively, a CCD image sensor may be used.

The embodiment of the invention may be changed or modified in various ways as necessary, as far as such changes and modifications do not depart from the scope of the claims of the invention hereinafter defined.

What is claimed is:

1. An information acquiring device for acquiring information on a target area using light, comprising:
a light source which emits light in a predetermined wavelength band;
a light source controller which controls the light source;
a projection optical system which projects the light emitted from the light source toward the target area;
alight receiving element which receives reflected light reflected on the target area for outputting a signal;
a storage which stores signal value information relating to a value of the signal outputted from the light receiving element; and
an information acquiring section which acquires three-dimensional information of an object in the target area based on the signal value information stored in the storage, wherein
the light source controller controls the light source to repeat emission and non-emission of the light,
the storage stores first signal value information relating to a value of a signal outputted from the light receiving element during a period when the light is emitted from the light source, and second signal value information relating to a value of a signal outputted from the light receiving element during a period when the light is not emitted from the light source, and
the information acquiring section acquires the three-dimensional information of the object in the target area, based on a subtraction result obtained by subtracting the second signal value information from the first signal value information stored in the storage.

2. The information acquiring device according to claim 1, wherein
the storage stores the second signal value information each time the light source is controlled not to emit the light, and
the information acquiring section acquires the three-dimensional information of the object in the target area, based on a subtraction result obtained by subtracting, from the first signal value information, the second signal value information stored in the storage immediately before or immediately after the first signal value information is stored in the storage.

3. The information acquiring device according to claim 1, wherein
the light receiving element includes an element which accumulates an electric charge in accordance with a received light amount for outputting a signal corresponding to the accumulated electric charge,
the information acquiring device further includes a shutter which controls exposure for the light receiving element, and a shutter controller which controls the shutter, and
the shutter controller controls the shutter in such a manner that a time of exposure for the light receiving element in acquiring the first signal value information, and a time of exposure for the light receiving element in acquiring the second signal value information are equal to each other.

4. The information acquiring device according to claim 1, wherein
the projection optical system projects the light emitted from the light source onto the target area with a dot matrix pattern, and
the light receiving element includes an image sensor operable to output a signal in accordance with a received light amount pixel by pixel.

5. The information acquiring device according to claim 4, wherein
the projection optical system includes a diffractive optical element which converts the light emitted from the light source into light having the dot matrix pattern by a diffractive action of the diffractive optical element.

6. An object detecting device, comprising:
an information acquiring device which acquires information on a target area using light,
the information acquiring device including:
a light source which emits light in a predetermined wavelength band;
a light source controller which controls the light source;
a projection optical system which projects the light emitted from the light source toward the target area;
a light receiving element which receives reflected light reflected on the target area for outputting a signal;
a storage which stores signal value information relating to a value of the signal outputted from the light receiving element; and
an information acquiring section which acquires three-dimensional information of an object in the target area based on the signal value information stored in the storage, wherein
the light source controller controls the light source to repeat emission and non-emission of the light,
the storage stores first signal value information relating to a value of a signal outputted from the light receiving element during a period when the light is emitted from the light source, and second signal value information relating to a value of a signal outputted from the light receiving element during a period when the light is not emitted from the light source, and
the information acquiring section acquires the three-dimensional information of the object in the target area, based on a subtraction result obtained by subtracting the second signal value information from the first signal value information stored in the storage.

7. The object detecting device according to claim 6, wherein
the storage stores the second signal value information each time the light source is controlled not to emit the light, and
the information acquiring section acquires the three-dimensional information of the object in the target area, based on a subtraction result obtained by subtracting, from the first signal value information, the second signal value information stored in the storage immediately before or immediately after the first signal value information is stored in the storage.

8. The object detecting device according to claim 6, wherein
the light receiving element includes an element which accumulates an electric charge in accordance with a received light amount for outputting a signal corresponding to the accumulated electric charge,
the information acquiring device further includes a shutter which controls exposure for the light receiving element, and a shutter controller which controls the shutter, and
the shutter controller controls the shutter in such a manner that a time of exposure for the light receiving element in acquiring the first signal value information, and a time of exposure for the light receiving element in acquiring the second signal value information are equal to each other.

9. The objet detecting device according to claim 6, wherein
the projection optical system projects the light emitted from the light source onto the target area with a dot matrix pattern, and
the light receiving element includes an image sensor operable to output a signal in accordance with a received light amount pixel by pixel.

10. The object detecting device according to claim 9, wherein
the projection optical system includes a diffractive optical element which converts the light emitted from the light source into light having the dot matrix pattern by a diffractive action of the diffractive optical element.
